(19) United States
(12) Patent Application Publication
(10) Pub. No.: US 2020/0408559 A1
(43) Pub. Date: Dec. 31, 2020

(54) METHOD FOR CONTROLLING VEHICLE NAVIGATION SYSTEM

(71) Applicant: PANASONIC INTELLECTUAL PROPERTY MANAGEMENT CO., LTD., Osaka (JP)

(72) Inventors: Akihiko IIDA, Kanagawa (JP); Susumu TSUBOSAKA, Kanagawa (JP)

(73) Assignee: PANASONIC INTELLECTUAL PROPERTY MANAGEMENT CO., LTD., Osaka (JP)

(21) Appl. No.: 16/910,981

(22) Filed: Jun. 24, 2020

(30) Foreign Application Priority Data
Jun. 28, 2019 (JP) 2019-122139

(51) Int. Cl. G01C 21/36; G01C 21/00; B60W 40/08; B60W 40/105; B60K 35/00; G06K 9/00

(52) U.S. Cl. CPC G01C 21/3664; G01C 21/3691; G01C 21/3608; G01C 21/3893; B60W 40/08; B60W 40/105; B60K 2370/175; G06K 9/00845; G06K 9/00302; B60W 2540/225; B60W 2556/10; B60K 2370/1438; B60K 2370/166; B60K 35/00

(57) ABSTRACT

A method for controlling a vehicle navigation system is provided. The vehicle navigation system includes: an in-vehicle camera configured to capture at least one occupant in a vehicle and detect a line-of-sight direction of the at least one occupant based on a captured image of the at least one occupant; and an in-vehicle device including a touchscreen configured to accept an operation of the at least one occupant and display information. The method includes: acquiring a detection result including a line-of-sight direction of a driver of the at least one occupant and the captured image; and accepting an input operation for information displayed on the touchscreen and accepting a touch operation on the touchscreen by an occupant in a passenger seat, based on the line-of-sight direction of the driver from the detection result.

### FIELD

The present disclosure relates to a vehicle navigation system and a method for controlling the vehicle navigation system.

### BACKGROUND

There is a demand for a data providing service technology in which a restaurant or an accommodation facility is displayed according to a hobby and a preference of a user, as disclosed by way of example in JP-A-2003-187146 and JP-A-2013-255168.

### SUMMARY

However, recently, in the data providing service technology, there is a demand for a technology for providing information in consideration of safe driving when providing event information or facility information in which an occupant of a vehicle is interested.

The present disclosure has been made in view of the above-described circumstances, and an object thereof is to provide a method for controlling a vehicle navigation system that can perform an input operation and information provision in consideration of safety according to vehicle information and a traveling state of a vehicle.

The present disclosure provides a method for controlling a vehicle navigation system, the vehicle navigation system including: an in-vehicle camera configured to capture at least one occupant in a vehicle and detect a line-of-sight direction of the at least one occupant based on a captured image of the at least one occupant; and an in-vehicle device including a touchscreen configured to accept an operation of the at least one occupant and display information, the method including: acquiring a detection result including a line-of-sight direction of a driver of the at least one occupant and the captured image; and accepting an input operation for information displayed on the touchscreen and accepting a touch operation on the touchscreen by an occupant in a passenger seat, based on the line-of-sight direction of the driver from the detection result.

According to the present disclosure, it is possible to perform the input operation and the information provision in consideration of safety according to the vehicle information and the traveling state of the vehicle.

### BRIEF DESCRIPTION OF DRAWINGS

FIG. 1 is a diagram showing an example of a vehicle interior of a vehicle.

FIG. 2 is a diagram showing an internal configuration example of the vehicle and a server according to a first embodiment.

FIG. 3 is a diagram showing an internal configuration example of an in-vehicle device according to the first embodiment.

FIG. 4 is a sequence diagram showing an operation procedure example of a vehicle navigation system according to the first embodiment.

FIG. 5 is a sequence diagram showing the operation procedure example of the vehicle navigation system according to the first embodiment.

FIG. 6 is a sequence diagram showing an operation procedure example of the vehicle navigation system according to the first embodiment.

FIG. 7 is a table showing a list of display timing examples of substitute object information.

FIG. 8 is a table showing an example of object information.

FIG. 9 is a diagram showing an example of a notification screen when the object information is not achievable.

FIG. 10 is a diagram showing an example of an output screen of substitute object information.

FIG. 11 is a diagram showing an example of an output screen of the substitute object information (details).

FIG. 12 is a diagram showing an example of a reservation screen for substitute object information.

### DETAILED DESCRIPTION

### Background to Contents of First Embodiment

Recently, there has been a demand for a data providing service technology for providing event information or facility information that an occupant of a vehicle is interested in by using an in-vehicle device provided in the vehicle. Further, recently, regarding the use of the in-vehicle device, when a driver performs an input operation while driving, a state where a hand of the driver is away from a steering wheel and a state where a line of sight of the driver is away from a front of the vehicle and faces the in-vehicle device are continued for a long time. As a result, safe driving may become difficult. As described above, in the in-vehicle device, there is a demand for the data providing service technology that enables a simple input without causing the hand of the driver that operates the steering wheel and the line of sight of the driver to be away from a front for a long time, and provides the event information or the facility information that the occupant of the vehicle is interested in. Therefore, in the following embodiment, an example of a vehicle navigation system and a method for controlling the vehicle navigation system will be described. The vehicle navigation system can perform an input operation and information provision in consideration of safety according to vehicle information and a traveling state of the vehicle.

Hereinafter, embodiments that specifically disclose configurations and functions of a vehicle, a vehicle navigation system, and a method for controlling the vehicle navigation system according to the present disclosure will be described in detail with reference to the drawings as appropriate. However, unnecessarily detailed description may be omitted. For example, detailed description of a well-known matter or repeated description of substantially the same configuration may be omitted. This is to avoid unnecessary redundancy in the following description and to facilitate understanding of those skilled in the art. It should be noted that the accompanying drawings and the following description are provided for a thorough understanding of the present disclosure by those skilled in the art, and are not intended to limit the subject matter recited in the claims.

### First Embodiment

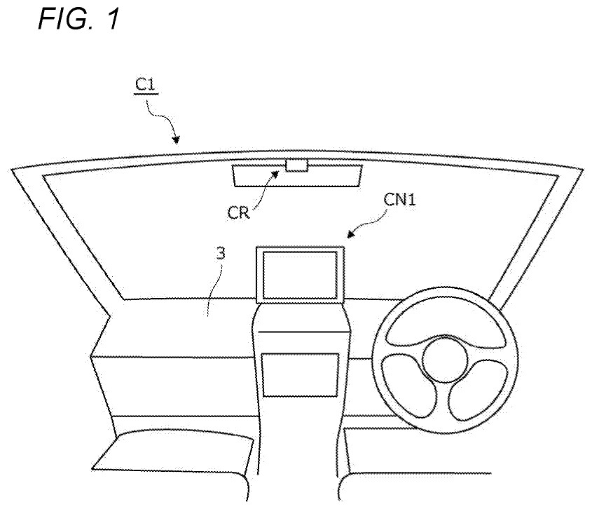

FIG. 1 is a diagram showing an example of a vehicle interior of a vehicle. The vehicle interior of a vehicle C1 is provided with a dashboard 3, an in-vehicle device CN1, and a camera CR.

In FIG. 1, the in-vehicle device CN1 is installed on the dashboard 3. It goes without saying that an installation location of the in-vehicle device CN1 is not limited to the example shown in FIG. 1.

The camera CR that is an example of an in-vehicle camera is installed on, for example, a room mirror or a windshield, and is installed to be able to capture an occupant in the vehicle C1 and a face of the occupant. The camera CR is communicably connected to the in-vehicle device CN1 and transmits a captured image to the in-vehicle device CN1.

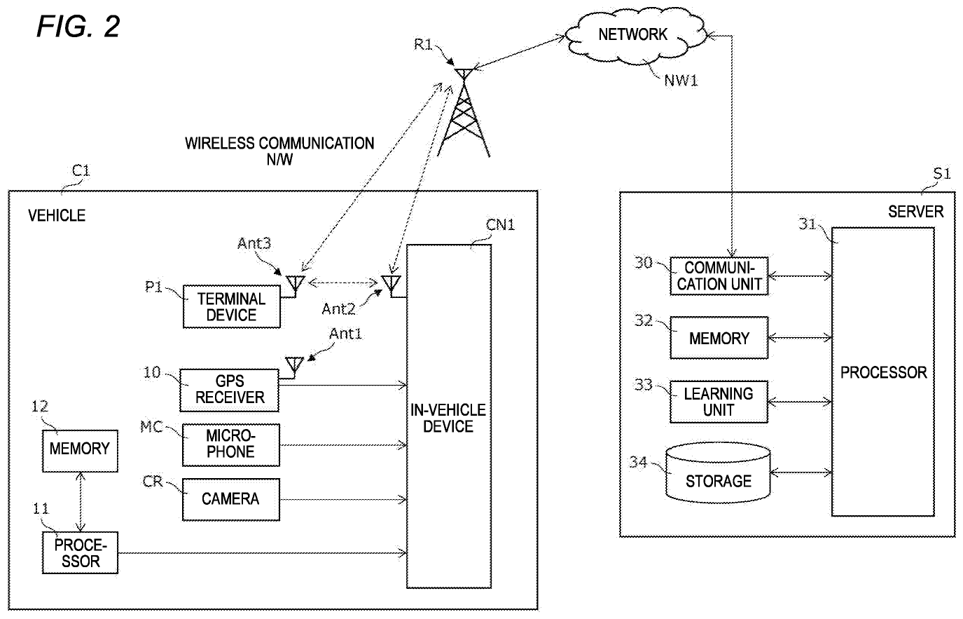

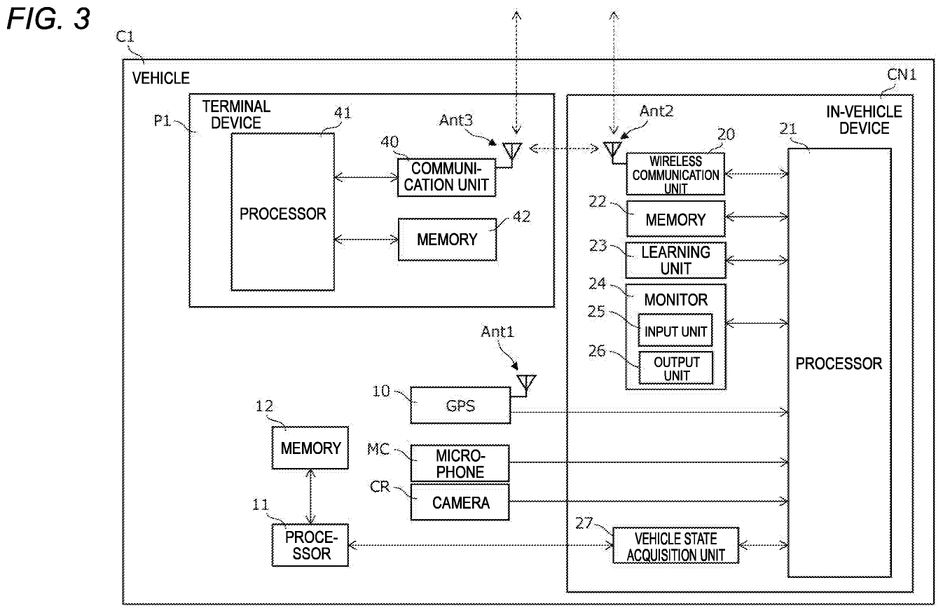

Next, an internal configuration example of the vehicle navigation system will be described with reference to FIGS. 2 and 3. The vehicle navigation system according to a first embodiment is a system including the vehicle C1, a base station R1, a backbone network NW1, a server S1, a plurality of intelligent transport systems (ITS) spots (registered trademark) (not shown) provided on a roadside of a road, and a plurality of artificial satellites (not shown) that transmit satellite positioning signals including a current traveling position of the vehicle C1. The vehicle navigation system may be a system including the vehicle C1, the plurality of ITS spots (registered trademark) (not shown), and the plurality of artificial satellites (not shown). Further, the vehicle navigation system may be a system including devices in the vehicle C1 (that is, the vehicle C1, the in-vehicle device CN1, and a terminal device P1), or may be a system configured to include the in-vehicle device CN1, the base station R1, the backbone network NW1, and the server S1.

FIG. 2 is a diagram showing an internal configuration example of the vehicle C1 and the server S1 according to the first embodiment. FIG. 3 is a diagram showing an internal configuration example of the in-vehicle device according to the first embodiment. In the figures shown in FIGS. 2 and 3, illustration of the plurality of roadside devices and the plurality of artificial satellites is omitted. Further, although an example of one vehicle is shown in order to simplify description in FIG. 2, a plurality of vehicles other than the vehicle C1 may be communicably connected to the server S1 via the base station R1 and the backbone network NW1.

The vehicle C1 includes a GPS receiver 10, a processor 11, a memory 12, the camera CR, a microphone MC, the in-vehicle device CN1, and the terminal device P1. The vehicle C1 is communicably connected to the base station R1, the plurality of ITS spots (registered trademark) (not shown), and the plurality of artificial satellites (not shown) by using wireless communication net work (N/W).

The vehicle C1 according to the first embodiment is not limited to a vehicle manually driven by a driver, and may be an automated driving vehicle. Regarding the automated driving vehicle, driving automation levels to be described below are defined in 2016 by the National Highway Traffic Safety Administration (NHTSA) that is one of organizations of the United States Department of Transportation. The automation levels are distinguished based on whether a person mainly responsible for monitoring a driving environment is a human or an automated driving system of the vehicle. Hereinafter, the driving automation levels will be described.

At the driving automation level 0, a human performs all driving (in other words, there is no automation of driving). At the driving automation level 1, the automated driving system of the vehicle occasionally assists a human driver so as to perform some driving control. At the driving automation level 2, the automated driving system of the vehicle performs some driving control. The human monitors a driving environment at the driving automation level 2. The automated driving system of the vehicle at the driving automation level 3 performs some driving control and monitors the driving environment in some cases. In monitoring the driving environment at the driving automation level 3, the automated driving system of the vehicle requires the human to drive the vehicle when requested by the automated driving system of the vehicle. At the driving automation level 4, the automated driving system of the vehicle performs driving control and monitors the driving environment. An automated system of the vehicle at the driving automation level 4 can perform driving control under a certain environment and condition without driving by the human. The automated driving system of the vehicle at the driving automation level 5 can perform all driving control under the same conditions as those of the human.

The GPS receiver 10 includes a satellite positioning antenna Ant1 that can receive the satellite positioning signals transmitted from the artificial satellites (not shown). The GPS receiver 10 detects a current traveling position of the vehicle C1 based on the received satellite positioning signals and transmits the detected traveling position to the in-vehicle device CN1.

A signal that can be received by the satellite positioning antenna Ant1 is not limited to a global positioning system (GPS) signal of the United States, and may be a signal transmitted from an artificial satellite that can provide a satellite positioning service such as a global navigation satellite system (GLONASS) of Russia or Galileo of Europe. Further, the satellite positioning antenna Ant1 may receive a satellite positioning signal transmitted by an artificial satellite that provides the satellite positioning service described above, and a quasi-zenith satellite signal that transmits a satellite positioning signal that can be augmented or corrected.

The GPS receiver 10 calculates information on a current traveling position of the vehicle C1 based on a received satellite positioning signal, and transmits the calculated information on the current traveling position to the processor 21. The calculation of the information on the current traveling position of the vehicle C1 based on the satellite positioning signal may be performed by the processor 21.

The processor 11 cooperates with the memory 12 so as to integrally perform various processings and control. The processor 11 uses, for example, an electronic control unit (ECU) that is an electronic circuit control device. Specifically, the processor 11 refers to a program and data held in the memory 12 and executes the program so as to implement functions of units.

The memory 12 includes, for example, a random access memory (RAM) serving as a work memory used when processings of the processor 11 are performed, and a read only memory (ROM) that stores data and a program which defines an operation of the processor 11. Data or information generated or acquired by the processor 11 is temporarily stored in the RAM. The program that defines the operation (for example, control of the vehicle according to a set driving automation level) of the processor 11 is written in the ROM.

The camera CR includes at least a lens (not shown) and an image sensor (not shown). The image sensor is, for example, a solid-state image-capturing element of a charged-coupled device (CCD) or a complementary metal oxide semiconductor (CMOS), and converts an optical image formed on an image-capturing surface into an electric signal.

The camera CR is installed at a position where the occupant in the vehicle C1 can be captured, and is communicably connected to the in-vehicle device CN1. The camera CR performs an image processing on a captured image in the vehicle C1, and detects a destination of a line of sight (hereinafter, referred to as line-of-sight direction) of an occupant positioned in a driver seat (hereinafter, referred to as driver) among occupants in the vehicle C1. The camera CR transmits the captured image and the detected line-of-sight direction of the driver to the in-vehicle device CN1.

The microphone MC collects a sound of the occupant in the vehicle C1, converts the collected sound into an electric signal, and transmits the converted electric signal to the in-vehicle device CN1. The microphone MC may be, for example, an omnidirectional microphone, a unidirectional microphone, or a phase-directional microphone, or a combination thereof. The microphone MC may be communicably connected to the in-vehicle device CN1 and installed in the vehicle C1 as shown in FIG. 1, or may be built in the in-vehicle device CN1.

The in-vehicle device CN1 is installed on the dashboard 3 in the vehicle interior of the vehicle C1. The in-vehicle device CN1 generates, for example, information on a route to an optional destination set by the occupant and outputs the generated route information to a monitor 24. Further, the in-vehicle device CN1 outputs, to the monitor 24, substitute object information generated for object information set by the occupant to be described later. The in-vehicle device CN1 includes a wireless communication unit 20, the processor 21, a memory 22, a learning unit 23, the monitor 24, and a vehicle state acquisition unit 27.

The object information referred to here is information that is input (set) by the occupant and indicates a schedule at the destination. The object information is generated by including a plurality of pieces of information such as destination information, desired arrival time information, building information, information on reserved time such as an event or a facility, information on expense that can be spent on the schedule, home-returning time information, and occupant composition (for example, the number of persons, an age, a gender) information.

The destination is, for example, a location such as a park, sea or a mountain, and a location such as a restaurant, a commercial facility, an amusement park, and an accommodation facility where the schedule is performed. The desired arrival time is a desired time at which the occupant should or desires to arrive at the destination. The building information is information indicating whether the schedule is performed indoors or outdoors. The object information is not limited to the contents described above, and may be information (hereinafter, referred to as event information) on, for example, an experience that requires a reservation and incurs expense or an event to participate in (for example, music live, an experience class). The event information may include a holding time or a reserved time serving as the desired arrival time, expense information such as participation expense, and the like.

The object information may be set in the terminal device P1 in advance by the occupant, or may be input from an input unit 25 of the in-vehicle device CN1. When the object information is set in the terminal device P1, the in-vehicle device CN1 receives the object information via the wireless communication unit 20.

On the other hand, the substitute object information is information for proposing a substitute schedule, which is generated when the schedule indicated by the object information in the in-vehicle device CN1 is determined to be unachievable. In the substitute object information, substitute schedule information according to a preference of the occupant is generated based on the occupant composition information, the home-returning time, the expense information, and the like included in the object information, among facilities and event information within a predetermined range (for example, facilities such as a commercial facility, a complex commercial facility, an amusement park, and a restaurant, or a predetermined play location or the like including outdoors, such as a park and sea) from the destination set by the occupant. Further, the substitute object information is further generated, as information on a schedule that is achievable at the destination according to the preference of the occupant, based on average stay time information, allowable stay time information, arrival time information for facility, facility usage evaluation information by the occupant (user) or other users, and the like.

The average stay time information is a time calculated based on a plurality of average stay times stored in a storage 34 of the server S1 and input by other users.

The allowable stay time information is generated when the home-returning time is included in the object information set by the occupant (user). The in-vehicle device CN1 calculates an allowable stay time based on an arrival time at a destination, the average stay time stored in the server S1 or past stay time of the occupant (user) stored in the learning unit 33, and a home-returning time or a desired arrival time for a set home or another destination (for example, an accommodation facility, a restaurant).

The usage evaluation information by the occupant (user) or other users is a satisfaction degree of the user set as an evaluation after usage of a facility thereof or participation in an event. The usage evaluation information of the occupant (user) may be stored in the terminal device P1 or the learning unit 33 in association with a facility or event information, or may be transmitted to the server S1 and stored in the storage 34 in association with occupant (user) information (specifically, information such as the number of occupants, an age, a gender, and the like). The usage evaluation information by other users is received from other vehicles (not shown) or other terminal devices (not shown), and is stored in the storage 34 in association with the occupant (user) information.

The participation expense information is information such as an entrance fee and a participation fee according to an age calculated based on the occupant composition. When a budget price is set in the object information set in advance, the in-vehicle device CN1 determines whether the participation expense information is larger than the budget price, and generates only a facility or event information not larger than the budget price as the substitute object information. When a restaurant is set as the facility, the participation expense information may be calculated based on average expense on food and drink actually consumed by other users. Information on the average expense on the food and drink actually consumed by other users is stored in the storage 34.

The wireless communication unit 20 includes an antenna Ant2, and is wirelessly communicably connected to the base station R1, the terminal device P1, and the plurality of ITS spots (registered trademark) installed on the roadside of the road (not shown). The antenna Ant2 is configured with a wireless circuit antenna and a DSRC antenna.

The wireless circuit antenna transmits a signal to and receives a signal from the base station R1 by the wireless communication network (N/W). The wireless communication N/W is a network provided according to a wireless communication standard such as a wireless local area network (LAN), a wireless wide area network (WAN), a fourth-generation mobile communication system (4G), a fifth-generation mobile communication system (5G), a Bluetooth (registered trademark), an NFC (registered trademark), or Wi-fi (registered trademark). The wireless circuit antenna may transmit/receive a signal not only to/from the base station R1 but also to/from the terminal device P1. The in-vehicle device CN1 uses the wireless circuit antenna so as to receive the object information from the terminal device P1. Further, the in-vehicle device CN1 uses the wireless circuit antenna so as to transmit the object information and the substitute object information to and receive the object information and the substitute object information from the server S1.

The dedicated short range communications (DSRC) antenna is an antenna for receiving a signal that is an example of a road information signal transmitted from the ITS spots, and can transmit high-speed and large-capacity information by using DSRC that is a wireless communication method. The road information signal received by the DSRC antenna is a signal including installation positions of the ITS spots and road traffic information (for example, during a traffic jam, under construction) that includes the installation positions of the ITS spots. The in-vehicle device CN1 acquires road traffic information on a route to a destination based on the received road information signal, and predicts an arrival time at the destination.

The wireless communication unit 20 uses the DSRC antenna so as to receive the object information set by the occupant in advance from the terminal device P1. The wireless communication unit 20 uses the wireless circuit antenna so as to transmit the received object information to the server S1 via the base station R1 and the backbone network NW1. The object information is not limited to being received from the terminal device P1, and may be directly input and acquired by the occupant from the input unit 25 of the in-vehicle device CN1.

The processor 21 uses, for example, a central processing unit (CPU) or a field programmable gate array (FPGA), and cooperates with the memory 22 so as to perform various processings and control. Specifically, the processor 21 refers to a program and data held in the memory 22 and executes the program so as to implement functions of units. The functions of the units include, for example, a function of generating information on a route to a destination based on the object information received from the terminal device P1, and a function of predicting an arrival time at the destination and a function of determining whether a schedule indicated by the object information is achievable, based on the information on the current traveling position of the vehicle C1 received from the GPS receiver 10 and road information such as traffic information received from the wireless communication unit 20.

Hereinafter, a method for determining, based on the object information, whether the schedule indicated by the object information is achievable will be described.

The processor 21 generates information on a route from a current traveling position to a destination based on destination information of the object information received from the terminal device P1 and information on the current traveling position of the vehicle C1 received from the GPS receiver 10. The information on the current traveling position of the vehicle C1 is not limited to whether the vehicle C1 is traveling (that is, whether the vehicle C1 is stopped), and may be positional information on the current vehicle C1.

Based on the generated route information, the processor 21 receives the road traffic information (for example, during a traffic jam, under construction) included in the route information from the ITS spots and predicts an arrival time at the destination. Here, the processor 21 determines whether the predicted arrival time at the destination is in time for the desired arrival time included in the object information. When it is determined that the arrival time at the destination is not in time for the desired arrival time, the processor 21 generates notification information indicating that the schedule indicated by the object information is not achievable, and outputs the generated notification information to an output unit 26 of the monitor 24. The desired arrival time set in advance is simply an arrival time at a destination desired by the occupant. When an arrival time, such as reservation time of a facility and a holding time of an event, is set as a time at which achievement of the schedule indicated by the object information is not difficult, the processor 21 generates notification information indicating that arrival is not possible at the desired arrival time and outputs the generated notification information to the output unit 26.

When it is determined that the arrival time at the destination is in time for the desired arrival time, the processor 21 uses the wireless communication unit 20 so as to acquire weather information of the destination. The processor 21 determines whether the building information of the object information is outdoors while outputting the acquired weather information of the destination to the output unit 26. When information indicated by the building information is outdoors, the processor 21 determines whether the schedule indicated by the object information can be achieved, such as whether the weather information of the destination is rainy. At this time, the processor 21 may use the wireless communication unit 20 or the terminal device P1 so as to search a facility or event information of the object information and determine whether the schedule indicated by the object information is achievable. Further, when alerting information based on weather, such as a strong wind warning, a lightning warning, a tornado warning, and a wave warning, is acquired for a region including the destination, the processor 21 may simultaneously output the alerting information and issue a notification asking whether to perform or change the object information set in advance. When the schedule indicated by the object information is not achievable based on the weather information, the processor 21 generates a notification information indicating that the schedule indicated by the object information is not achievable, and outputs the generated notification information to the output unit 26 of the monitor 24.

When it is determined that the schedule indicated by the object information is achievable, the processor 21 starts guidance to the destination. On the other hand, when it is determined that achievement of the schedule indicated by the object information is impossible or difficult, the processor 21 transmits the object information set in advance to the server S1 via the base station R1 and the backbone network NW1 in order to generate the substitute object information.

The processor 21 receives the substitute object information generated by the server S1 and outputs the substitute object information to the output unit 26. The substitute object information generated by the server S1 may be plural instead of one. The processor 21 outputs at least one piece of substitute object information from the received substitute object information to the output unit 26.

When the schedule indicated by the object information is determined whether achievement is possible based on an arrival time, such as a holding time of an experience class or a holding time of an event, the processor 21 causes the terminal device P1 to search whether the schedule indicated by the object information is held at another time. When an activity such as the same experience class or event as that of the schedule indicated by the object information is held at another time, the processor 21 generates information on the activity at another time as the substitute object information and outputs the generated information to the output unit 26.

Here, a method for outputting the received substitute object information will be described. The output substitute object information is output including a summary (for example, a facility name, an event name) of the substitute object information. The substitute object information may be further output together with evaluation information or an image.

Based on whether a driving automation level of the vehicle C1 acquired from the vehicle state acquisition unit 27 to be described later is level 2 or higher, the processor 21 determines whether to output the received substitute object information to the output unit 26. While the vehicle C1 is manually driven by the driver, the processor 21 determines whether the driver looks at the monitor 24 based on a line-of-sight direction of the driver received from the camera CR. When the vehicle C1 is manually driven by the driver and the driver looks at the monitor 24, the processor 21 does not output the substitute object information to the output unit 26. Accordingly, the vehicle navigation system can perform an input operation and information provision in consideration of safety according to vehicle information and a traveling state of the vehicle.

When the substitute object information is not output to the output unit 26, the processor 21 may use a speaker (not shown) provided in the output unit 26 so as to output the substitute object information by sound. Further, information output by sound is not limited to the substitute object information, and for example, the notification information indicating that the achievement of the object information is impossible may be output by sound. When the substitute object information or the notification information is output by sound, the processor 21 may sound-recognize a sound of the occupant collected by the microphone MC and accept an input operation based on a sound-recognized recognition result. That is, regarding whether the object information is achievable and the substitute object information, the input unit 25 and the output unit 26 provided in the monitor 24 are used, so that the processor 21 may perform an input operation from the occupant and output control for the occupant in an interactive manner with the occupant in the vehicle C1.

The interactive input and output method may be used when a frustration degree is calculated from a facial expression of the occupant shown in a captured image captured by the camera CR, and the calculated frustration degree exceeds a predetermined degree. Accordingly, the vehicle navigation system can reduce the frustration degree of the occupant at an early stage, and can further perform an input operation by sound. Therefore, the driver can perform an input operation by sound while performing a driving operation safely.

When the substitute object information is output and while the vehicle C1 is manually driven by the driver, the processor 21 limits an input operation method for the substitute object information according to a position of the occupant. The processor 21 limits the input operation method by the driver to an input operation method based on line-of-sight detection using the camera CR, and limits an input operation method by an occupant in a passenger seat to an input operation method based on a touch operation on the monitor 24 (input unit 25). Even when the substitute object information is output, the processor 21 may perform the input operation and the output control based on the sound recognition.

When the substitute object information is output and when the driving automation level of the vehicle C1 is level 2 or higher, the processor 21 does not limit the input operation method for the substitute object information to the input operation method based on the line-of-sight detection using the camera CR. The processor 21 sets the input operation method for the driver to be possible not only by the line-of-sight detection but also by the touch operation on the monitor 24 (input unit 25).

Next, the input operation method for the substitute object information will be described. The input operation for the substitute object information is performed by an input operation based on a degree of interest of the occupant in the substitute object information, an input operation based on a sound of the occupant, an input operation based on a facial expression of the occupant, or a touch operation on the monitor 24 (input unit 25) by the occupant.

When the substitute object information is output, the processor 21 measures the degree of interest of the occupant in the substitute object information. The degree of interest referred to here indicates a degree of interest in the substitute object information output to the output unit 26, which is determined based on the facial expression of the occupant in the vehicle C1 captured by the camera CR, the line-of-sight direction of the driver detected by being captured by the camera CR, or the sound of the occupant in the vehicle C1 collected by the microphone MC.

The processor 21 analyzes a change in the facial expression of the occupant in the vehicle C1 captured by the camera CR before and after the output of the substitute object information. When the degree of interest based on the change in the facial expression of the occupant in the vehicle C1 is higher than a predetermined degree of interest, the processor 21 determines that the occupant in the vehicle C1 has a high degree of interest in the output substitute object information. When a plurality of pieces of substitute object information are output, the processor 21 may detect a line-of-sight direction of each occupant in the vehicle C1 captured by the camera CR, and may specify one piece of substitute object information from the plurality of pieces of substitute object information.

After the substitute object information is output, the processor 21 measures time when the line-of-sight direction of the driver detected by being captured by the camera CR faces the substitute object information. If a predetermined time elapses while the line-of-sight direction faces the substitute object information, the processor 21 determines that the driver has a high degree of interest in the output substitute object information. The processor 21 may detect the line-of-sight direction of each occupant in the vehicle C1 captured by the camera CR as described above so as to measure time thereof, and may specify one piece of substitute object information from the plurality of pieces of substitute object information.

Before and after the output of the substitute object information, the processor 21 performs sound recognition on the sound of the occupant in the vehicle C1 collected by the microphone MC, and determines that a degree of interest in the substitute object information is high based on a content of the recognized sound (specifically, a positive utterance content, a change in a tone of sound, or the like). When the plurality of pieces of substitute object information are output, the processor 21 may collate the plurality of pieces of output substitute object information with an utterance word included in the recognized sound, and may specify one piece of substitute object information from the plurality of pieces of substitute object information.

The processor 21 increases display time for substitute object information determined to arouse a high degree of interest or selected by the occupant, or displays detailed information on the same substitute object information. The processor 21 sets the substitute object information as latest object information when a degree of interest is determined again or an input operation is accepted for the detailed information on the substitute object information in which the occupant has a high degree of interest. The detailed information referred to here is, for example, another photograph, description, average stay time, expense, an average budget, and the like that are related to the substitute object information.

On the other hand, when it is determined that the occupant in the vehicle C1 has a low degree of interest in the plurality of pieces of output substitute object information, the processor 21 outputs a plurality of pieces of other substitute object information.

When the processor 21 transmits the object information or the substitute object information to the server S1 or receives the object information or the substitute object information from the server S1 and a data amount to be transmitted or received is larger than a predetermined data amount, the substitute object information may be generated by the learning unit 23. Accordingly, the processor 21 can reduce communication expense of the terminal device P1.

The processor 21 constantly accepts a change operation for the object information such as a change in a destination, and a change in a desired arrival time. The change operation may be performed when the in-vehicle device CN1 receives a change instruction or a change content input to the terminal device P1. Based on the changed objective information (hereinafter, referred to as forced substitute request information), the processor 21 determines whether the schedule is achievable or generates the substitute object information. Accordingly, the occupant (user) can change the object information at any time.

The memory 22 includes, for example, a random access memory (RAM) serving as a work memory used when processings of the processor 11 are performed, and a read only memory (ROM) that stores data and a program which defines an operation of the processor 11. Data or information generated or acquired by the processor 11 is temporarily stored in the RAM. The program that defines the operation of the processor 11 (for example, output control and input control of the substitute object information) is written in the ROM.

Based on the object information received from the terminal device P1 or output from the processor 21, the occupant composition, the evaluation of the schedule indicated by the object information, and the like, the learning unit 23 learns a schedule, a budget, a time period, and the like of preference for each terminal device or each occupant. The learning unit 23 stores a learning result as learning data for generating the substitute object information.

The monitor 24, which is an example of a touchscreen, is a touchscreen that can display guidance information on a route to a destination, the plurality of pieces of substitute object information, and the like. The monitor 24 includes the input unit 25 and the output unit 26.

The input unit 25 is a user interface that accepts a touch operation by the occupant (user). The input unit 25 converts input information into an input signal and outputs the converted input signal to the processor 21.

The output unit 26 is a so-called speaker, and outputs a sound based on a control signal input from the processor 21.

The vehicle state acquisition unit 27 receives, from the processor 11, a driving automation level set for the vehicle C1 and a traveling speed of the vehicle C1. The vehicle state acquisition unit 27 outputs the received driving automation level and traveling speed information to the processor 21.

The terminal device P1 includes a wireless circuit antenna Ant3, and is a smartphone or tablet terminal wirelessly communicably connected to the in-vehicle device CN1 and the base station R1. The terminal device P1 transmits information such as a destination set by the occupant and the desired arrival time at the destination to the in-vehicle device CN1. The wireless circuit antenna Ant3 is configured with a plurality of antennae such as a DSRC antenna and a wireless circuit antenna.

A processor 41 uses, for example, a CPU or an FPGA, and cooperates with a memory 42 so as to perform various processings and control. Specifically, the processor 41 refers to a program and data held in the memory 42 and executes the program, so that functions of units are implemented. The functions of the units include, for example, a function of transmitting the input object information, and the like.

The memory 42 includes, for example, a RAM serving as a work memory used when processings of the processor 41 are performed, and a ROM that stores data and a program which defines an operation of the processor 41. Data or information generated or acquired by the processor 41 is temporarily stored in the RAM. The program that defines the operation of the processor 41 is written in the ROM.

The base station R1 is a wireless base station used in a cellular network provided by an existing carrier. The base station R1 is communicably connected to the in-vehicle device CN1 and the terminal device P1 through the wireless communication N/W, and is communicably connected to the server S1 through the backbone network NW1. The wireless communication N/W is a network provided according to a wireless communication standard such as a wireless LAN, a wireless WAN, a 4G (fourth-generation mobile communication system), a 5G (fifth-generation mobile communication system), or Wi-fi (registered trademark).

The backbone network NW1 is communicably connected to the base station R1 and the server S1.

The server S1 is communicably connected to the in-vehicle device CN1 and the base station R1 via the backbone network NW1. The server S1 receives the object information received from the in-vehicle device CN1 or the terminal device P1, and generates the substitute object information based on the received object information.

A communication unit 30 is communicably connected to the terminal device P1 and the in-vehicle device CN1 via the backbone network NW1 and the base station R1.

A processor 31 uses, for example, a CPU or FPGA, and cooperates with a memory 32 so as to perform various processings and control. Specifically, the processor 31 refers to a program and data held in the memory 32 and executes the program, so that functions of units are implemented. The functions of the units include, for example, a function of, based on the destination information received from the terminal device P1 or the in-vehicle device CN1, referring to past object information of the terminal device P1 and evaluation information thereof stored in the learning unit 33 and generating the substitute object information, and the like.

The memory 32 includes, for example, a RAM serving as a work memory used when processings of the processor 31 are performed, and a ROM that stores data and a program which defines an operation of the processor 31. Data or information generated or acquired by the processor 31 is temporarily stored in the RAM. The program that defines the operation of the processor 31 is written in the ROM.

Based on the object information received from the terminal device P1 or the in-vehicle device CN1, the occupant composition, the evaluation of the schedule indicated by the object information, and the like, the learning unit 33 learns a schedule, a budget, a time period, and the like of preference for each terminal device, each in-vehicle device, or each occupant. The learning unit 33 stores a learning result as learning data for generating the substitute object information, and generates the substitute object information by using the stored learning data.

The storage 34 stores the object information received from the terminal device P1 or the in-vehicle device CN1, the occupant composition, the evaluation of the schedule indicated by the object information, and the like for each terminal device or each in-vehicle device.

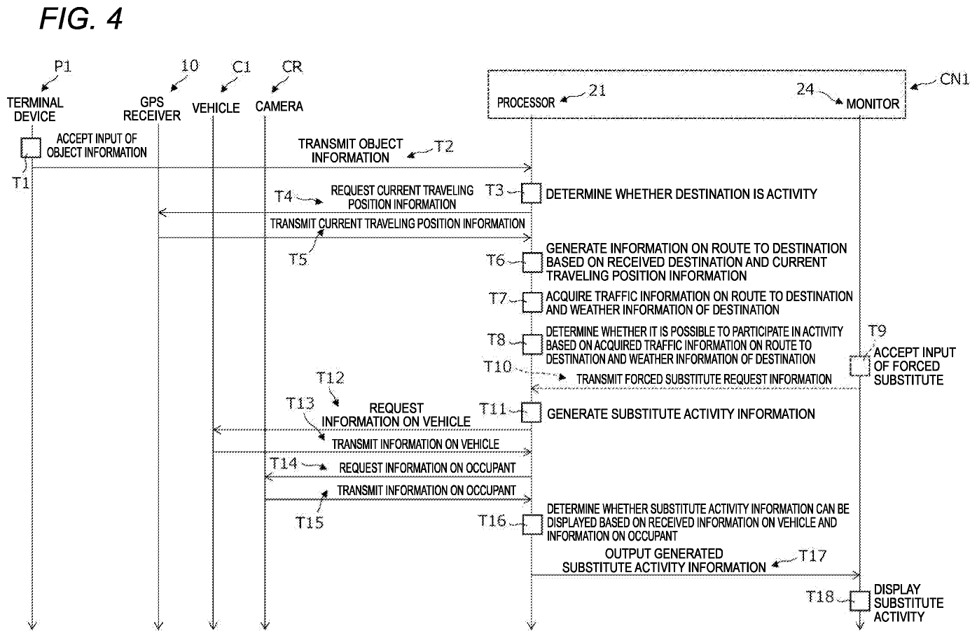

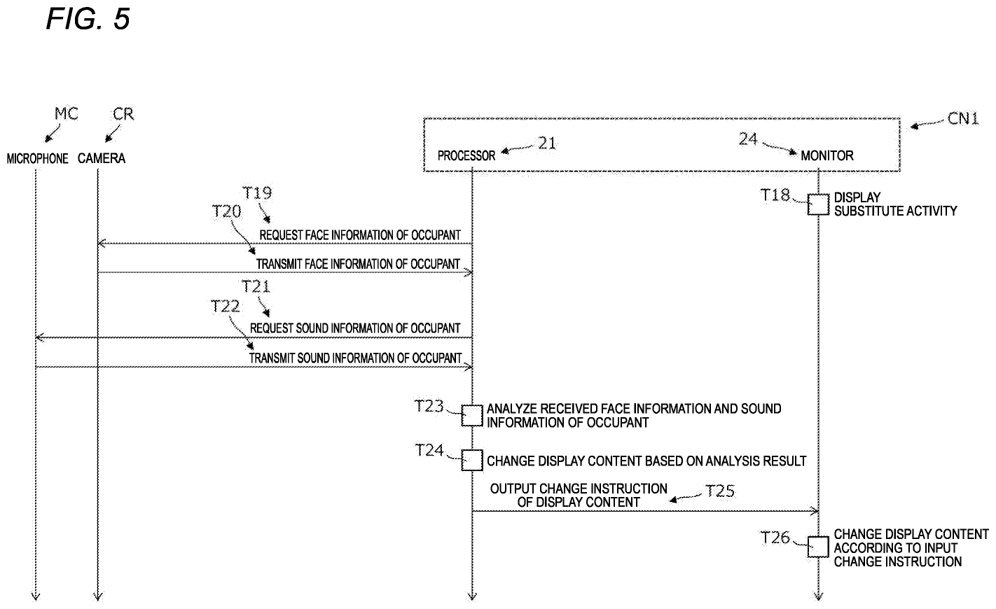

An operation procedure example of the vehicle navigation system will be described with reference to FIGS. 4 and 5. FIG. 4 is a sequence diagram showing the operation procedure example of the vehicle navigation system according to the first embodiment. FIG. 5 is a sequence diagram showing the operation procedure example of the vehicle navigation system according to the first embodiment. The vehicle navigation system shown in FIGS. 4 and 5 shows an example including the vehicle C1, the in-vehicle device CN1, the terminal device P1, and the server S1, but the configuration example is not limited thereto.

The terminal device P1 accepts an input operation of the object information by the occupant (user) (T1). The input of the object information may be an input operation to the input unit 25 of the monitor 24.

The terminal device P1 transmits the object information input by the occupant (user) to the in-vehicle device CN1 (T2). The terminal device P1 may also similarly transmit the object information to the server S1 at a timing at which the object information is transmitted to the in-vehicle device CN1.

The processor 21 determines whether a destination of the object information received from the terminal device P1 is a predetermined location such as a home or a company set in advance. When the destination is not the predetermined location such as the home or the company, the processor 21 determines that the set destination is an activity (that is, a schedule for eating, playing, shopping, going out, and the like) (T3).

The processor 21 requests a current traveling position of the vehicle C1 from the GPS receiver 10 in order to generate information on a route to the destination (T4).

The GPS receiver 10 calculates information on the current traveling position of the vehicle C1 based on satellite positioning signals received from the artificial satellites (not shown), and transmits the calculated information to the processor 21 (T5). The calculation related to the information on the current traveling position of the vehicle C1 based on the satellite positioning signals may be performed by the processor 21.

The processor 21 generates the information on the route to the destination based on the destination included in the object information received from the terminal device P1 and the current traveling position of the vehicle C1 received from the GPS receiver 10 (T6). The processor 21 generates a plurality of pieces of route information, and sets any one route information selected by the occupant (user) from the plurality of pieces of generated route information as the information on the route to the destination.

Based on the information on the route to the set destination, the processor 21 uses the wireless communication unit 20 so as to acquire traffic information on the route and weather information of the destination (T7). The processor 21 may use the terminal device P1 so as to acquire the traffic information on the route and the weather information of the destination.

The processor 21 predicts an arrival time based on the acquired traffic information on the route to the destination. Based on the predicted arrival time at the destination and the acquired weather information of the destination, the processor 21 determines whether achievement (participation) of a schedule (that is, an activity) indicated by the object information is possible (T8).

Here, an operation procedure example when there is forced substitute request information will be described. The input unit 25 of the monitor 24 constantly accepts input of changed object information, such as a change in the destination and a change in the desired arrival time, as the forced substitute request information (T9).

When the forced substitute request information is input by the occupant (user), the input unit 25 outputs the forced substitute request information (that is, changed object information) to the processor 21 (T10).

The processings in steps T9 and T10 may be performed with priority at any time regardless of operation procedure examples of the vehicle navigation system shown in FIGS. 4 to 6. Further, the processings in steps T9 and T10 may be performed by the terminal device P1.

In the processing of step T8, the processor 21 generates the substitute object information (that is, substitute activity information) when the schedule (that is, activity) indicated by the object information is not achievable (T11). The processor 21 determines whether a data communication amount between the terminal device P1 and the server S1 is larger than a predetermined data amount. When the data communication amount is larger than the predetermined data amount, the processor 21 or the terminal device P1 generates the substitute object information. On the other hand, when the data communication amount is not larger than the predetermined data amount, the processor 21 transmits the object information to the server S1 via the terminal device P1 and causes the server S1 to generate the substitute object information. The number of pieces of generated substitute object information may be plural.

The processor 21 requests information on the vehicle C1 from the processor 11 (T12). The information on the vehicle C1 referred to here is a driving automation level set for the vehicle C1 and traveling speed information of the vehicle C1.

The processor 11 transmits the information on the vehicle C1 to the processor 21 (T13).

The processor 21 requests information on the occupant in the vehicle C1 from the camera CR (T14). The information on the occupant referred to here is information such as a line-of-sight direction of each occupant, a position of the occupant, and the number of occupants.

The camera CR transmits the information on the occupant in the vehicle C1 to the processor 21 (T15).

Based on the received information on the vehicle C1 and the information on the occupant in the vehicle C1, the processor 21 determines whether to display the generated substitute object information (that is, substitute activity information) (T16). Specifically, when the driving automation level of the vehicle C1 is level 1 or while manual driving is performed, the processor 21 determines whether the driver looks at the monitor 24 based on the line-of-sight direction of the driver received from the camera CR. While the vehicle C1 is manually driven by the driver and the driver looks at the monitor 24, the processor 21 determines not to output the substitute object information to the output unit 26.

When determining in the processing of step T16 that the substitute object information can be displayed, the processor 21 outputs the generated substitute object information (that is, substitute activity information) to the monitor 24 (T17). When there are a plurality of pieces of substitute object information, the number of pieces of substitute object information simultaneously output to the output unit 26 may be one or more. Further, regarding an output order when the plurality of pieces of substitute object information are simultaneously output, any number of pieces of substitute object information selected in a descending order of the evaluation information or randomly selected may be output.

The monitor 24 displays the input substitute object information (that is, substitute activity information) on the output unit 26 (T18). When the substitute object information (that is, substitute activity information) is output by sound, the monitor 24 may output the substitute object information (that is, substitute activity information) by sound regardless of whether the substitute object information can be displayed in step T16.

When the substitute object information (that is, substitute activity information) is displayed, the processor 21 requests face information of the occupant in the vehicle C1 from the camera CR (T19). The face information referred to here indicates information on the line-of-sight direction of the occupant and a facial expression of the occupant.

The camera CR analyzes face information of each occupant based on a captured image in the vehicle C1. The camera CR transmits the face information of the occupant in the vehicle C1 to the processor 21 (T20).

When the substitute object information (that is, substitute activity information) is displayed, the processor 21 requests sound information of the occupant in the vehicle C1 from the microphone MC (T21).

The microphone MC collects a sound of the occupant in the vehicle C1, converts the collected sound into an audio signal, and transmits the converted audio signal to the processor 21 (T22).

The processor 21 analyzes the received face information and sound information of the occupant in the vehicle C1 (T23). Specifically, the processor 21 determines a degree of interest of the occupant from the received the face information of the occupant. Further, the processor 21 performs sound recognition on the received sound information of the occupant, analyzes an utterance content or a tone of sound, and determines the degree of interest of the occupant.

Based on an analysis result in the processing of step T23, the processor 21 determines the degree of interest of the occupant in each of one or the plurality of pieces of substitute object information (that is, substitute activity information) (T24).

When the degree of interest of the occupant in the vehicle C1 is not higher than a predetermined degree of interest, the processor 21 outputs, to the monitor 24, an instruction for displaying other substitute object information (T25). When the degree of interest of the occupant in the vehicle C1 is higher than the predetermined degree of interest for one piece of substitute object information, the processor 21 outputs an instruction to increase display time or an instruction to display detailed information regarding the same substitute object information.

The monitor 24 displays other substitute object information (that is, substitute activity information) on the output unit 26 according to the input change instruction (T26).

As described above, while the vehicle C1 is manually driven by the driver and the driver looks at the monitor 24, the vehicle navigation system according to the first embodiment does not output the substitute object information. Therefore, the vehicle navigation system can perform the input operation and the information provision (that is, output control) in consideration of safety according to driving automation level vehicle information of the vehicle C1 and a traveling state of the vehicle.

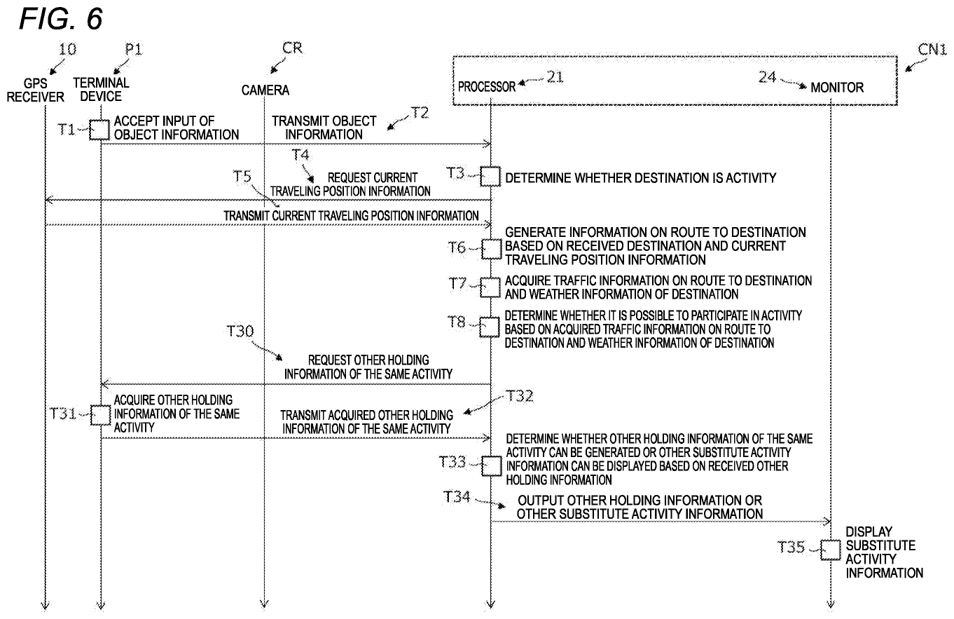

Referring to FIG. 6, an operation procedure example of the vehicle navigation system when the schedule indicated by the object information is an activity such as a holding time of an experience class or a holding time of an event, and the same activity is held at another time will be described. FIG. 6 is a sequence diagram showing the operation procedure example of the vehicle navigation system according to the first embodiment. The vehicle navigation system shown in FIG. 6, which is similar to the vehicle navigation system shown in FIGS. 4 and 5, shows an example including the vehicle C1, the in-vehicle device CN1, the terminal device P1, and the server S1. However, the configuration example is not limited thereto.

The operation procedure example of the vehicle navigation system shown in FIG. 6 includes the same processing as that of the operation procedure example of the vehicle navigation system shown in FIG. 4. In FIG. 6, steps T1 to T8, which are the same processings as those of the operation procedure example of the vehicle navigation system shown in FIG. 4, will be denoted by the same reference numerals and description thereof will be omitted.

In step T8, when the schedule (that is, activity) indicated by the object information is not achievable, the processor 21 requests the terminal device P1 to search for other holding information in the same schedule (activity) as the schedule indicated by the object information in order to search whether the schedule indicated by the object information is held at another time (T30).

The terminal device P1 searches for other holding information in the same schedule (activity) as the schedule indicated by the object information and acquires a search result (T31).

The terminal device P1 transmits the acquired other holding information in the same schedule (activity) to the processor 21 (T32). When there is no other holding information, the terminal device P1 transmits information indicating that there is no other holding information to the processor 21.

The processor 21 determines whether other holding information can be generated and displayed (output) based on the received other holding information and the home-returning time in the object information. Further, when receiving the information indicating that there is no other holding information from the terminal device P1, the processor 21 generates the substitute object information (that is, substitute activity information), performs a processing similar to the processing in step T16, and determines whether display (output) is possible (T33).

When determining in the processing of step T33 that other holding information or substitute object information can be displayed, the processor 21 outputs the generated other holding information or substitute object information (that is, substitute activity information) to the monitor 24 (T34).

The monitor 24 displays the input substitute object information (that is, substitute activity information) on the output unit 26 (T35). When other holding information or substitute object information (that is, substitute activity information) is output by sound, the monitor 24 may output the substitute object information (that is, substitute activity information) by sound regardless of whether the substitute object information can be displayed in step T16.

As described above, the vehicle navigation system according to the first embodiment can adaptively create the substitute object information including other holding information and provide information according to the schedule indicated by the object information. Accordingly, the occupant can acquire information on an activity at another holding time without significantly changing an originally desired schedule, and can change the schedule to another schedule by the substitute object information when there is a time constraint such as the home-returning time.

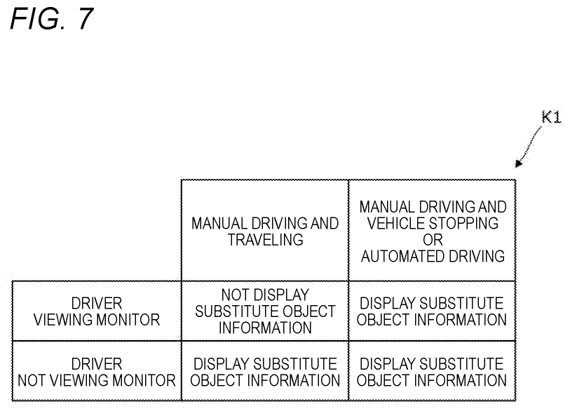

FIG. 7 is a table showing display condition examples of the substitute object information. A display condition K1 is a condition regarding whether to display (output) other holding information or substitute object information on the output unit 26. While the vehicle C1 is manually driven by the driver and the driver views the monitor 24, the processor 21 does not cause the output unit 26 to display the substitute object information. Even when the vehicle C1 is manually driven by the driver and the driver looks at the monitor 24, the processor 21 causes the substitute object information to be displayed when the vehicle C1 is stopped or moved at a predetermined traveling distance while maintaining a predetermined traveling speed (that is, during a traffic jam).

Specifically, the predetermined speed differs between an expressway and an ordinary road. The processor 21 determines that there is a traffic jam when a traveling speed of the vehicle C1 that travels on the expressway is 40 km/h or less, or when a state where the vehicle C1 is repeatedly stopped and started continues for 1 km or more and 15 minutes or more, and causes other holding information or substitute object information to be displayed. The traveling speed on the expressway may be different for each expressway, and may be, for example, 20 km/h or less on a metropolitan expressway. Further, the processor 21 determines that there is the traffic jam when a traveling speed of the vehicle C1 that travels on the ordinary road is 10 km/h or less, and causes other holding information or substitute object information to be displayed.

While the driver does not view the monitor 24, the processor 21 causes the substitute object information to be displayed even when the vehicle C1 is manually driven by the driver or a driving automation level is level 1.

Accordingly, the vehicle navigation system can perform the input operation and the information provision (that is, output control) in consideration of safety according to the driving automation level vehicle information of the vehicle C1 and the traveling state of the vehicle.

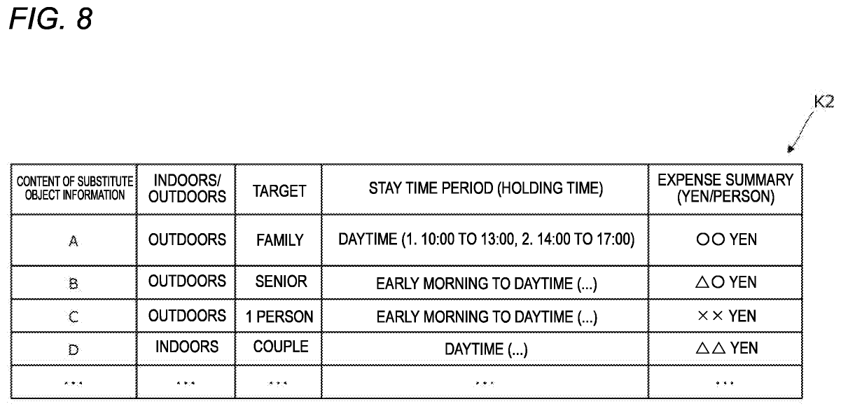

FIG. 8 is a table showing a storage example K2 of object information data. The storage 34 stores the received object information by dividing the object information into a plurality of items such as a content of the object information, a location, a target, a stay time period (holding time), and an expense summary. The storage 34 may store the object information received from the terminal device P1 or the in-vehicle device CN1 for each terminal device or vehicle.

The storage example K2 shown in FIG. 8 is a storage example of object information of a plurality of users stored in the storage 34. As shown in the storage example K2, the storage 34 stores the plurality of pieces of received object information as “object information content: A, location: outdoors, target: family, stay time period (holding time): daytime (1. 10:00 to 13:00, 2. 14:00 to 17:00), expense summary (yen/person): ◯◯ yen”, “object information content: B, location: outdoors, target: senior, stay time period (holding time): early morning to daytime ( . . . ), expense summary (yen/person): Δ◯ yen”, “condition content: C, location: outdoors, target: one person, stay time period (holding time): early morning to daytime ( . . . ), expense summary (yen/person): xx yen”, “object information content: D, location: indoors, target: couple, stay time period (holding time): daytime ( . . . ), expense summary (yen/person): ΔΔ yen”.

The target shown in FIG. 8 is a target obtained by classifying a configuration based on factors such as the number of occupants, gender, and age according to a facility use group or an event participation group, for example, is classified into a family, a senior, one person, and a couple.

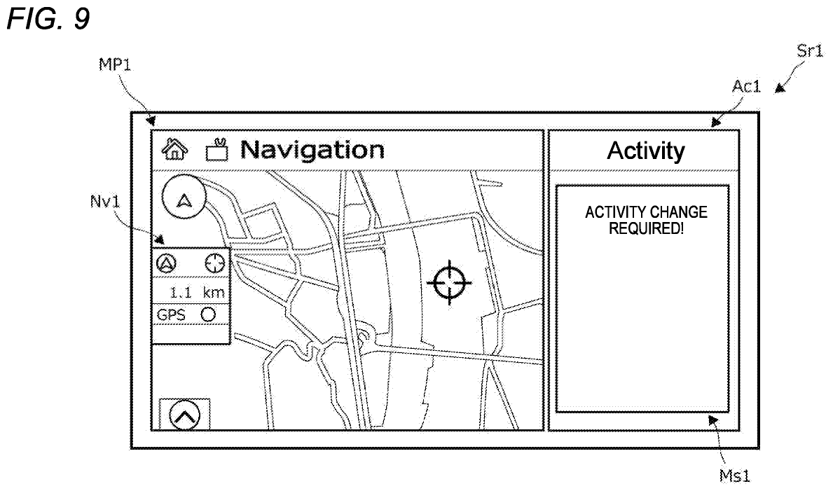

FIG. 9 is a diagram showing an example of a notification screen Sr1 when the object information is not achievable. The notification screen Sr1 is generated by the processor 21 and output to the monitor 24.

A map MP1 shows a map including current traveling position information of the vehicle C1 on the map, route information, and the like. The map MP1 may show a peripheral map of the vehicle C1 as shown in FIG. 9.

Navigation information Nv1 displays information including information on route guidance to a destination such as north, south, east, and west in the map MP1, a distance from the destination, a scheduled arrival time at the destination, and the like.

A display region Ac1 is a display region for displaying notification information on the set object information or information on the generated substitute object information.

A notification Ms' is an example of a message indicating that a schedule indicated by the currently set object information is not achievable, and in this case, “activity needs to be changed!” is displayed. The notification Ms' may be output by sound.

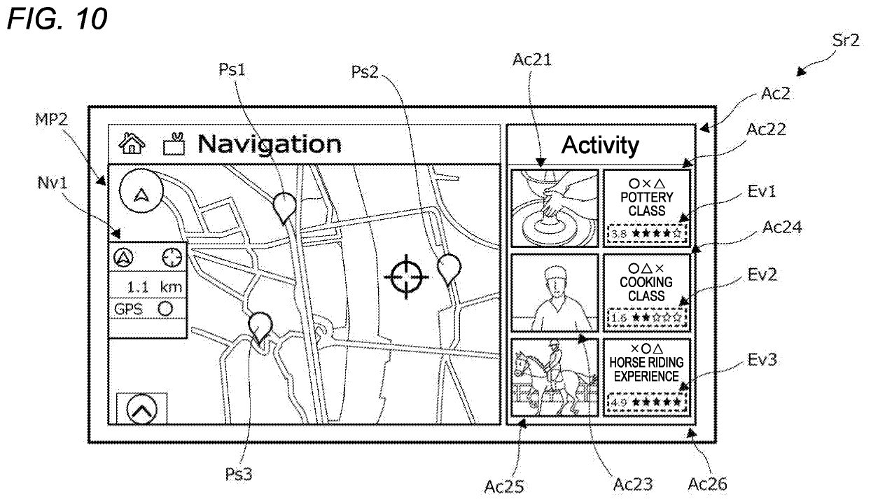

FIG. 10 is a diagram showing an example of an output screen Sr2 of substitute object information (activities). FIG. 10 shows an example in which a plurality of pieces of generated substitute object information are displayed in a display region Ac2. The number of pieces of displayed substitute object information may be one.

In the display region Ac2 shown in FIG. 10, three pieces of generated substitute object information are displayed. A summary Ac22 includes a “◯xΔ pottery class” that is summary information of substitute object information and evaluation information Ev1 for the substitute object information. An image Ac21 is an image related to the substitute object information indicated by the summary Ac22.

A summary Ac24 includes a “◯Δx cooking class” that is summary information of substitute object information and evaluation information Ev2 for the substitute object information. An image Ac23 is an image related to the substitute object information indicated by the summary Ac24.

A summary Ac26 includes a “xΔ◯ horse riding experience” that is summary information of substitute object information and evaluation information Ev3 for the substitute object information. An image Ac25 is an image related to the substitute object information indicated by the summary Ac26.

A map MP2 is displayed including positions of facilities (locations) where the three pieces of substitute object information are held. For example, a destination Ps1 shows the position of the facility where the “◯xΔ pottery class” shown in the summary Ac22 is held. A destination Ps2 shows the position of the facility where the “◯Δx cooking class” shown in the summary Ac24 is held. A destination Ps3 shows the position of the facility where the “xΔ◯ horse riding experience” shown in the summary Ac26 is held.

The navigation information Nv1 displays information including information on route guidance to a destination such as north, south, east, and west in the map MP2, a distance from the destination, a scheduled arrival time at the destination, and the like. In the navigation information Nv1 shown in FIG. 10, since the substitute object information has been displayed but not selected, the information on the distance from the original destination and the like are continuously displayed.

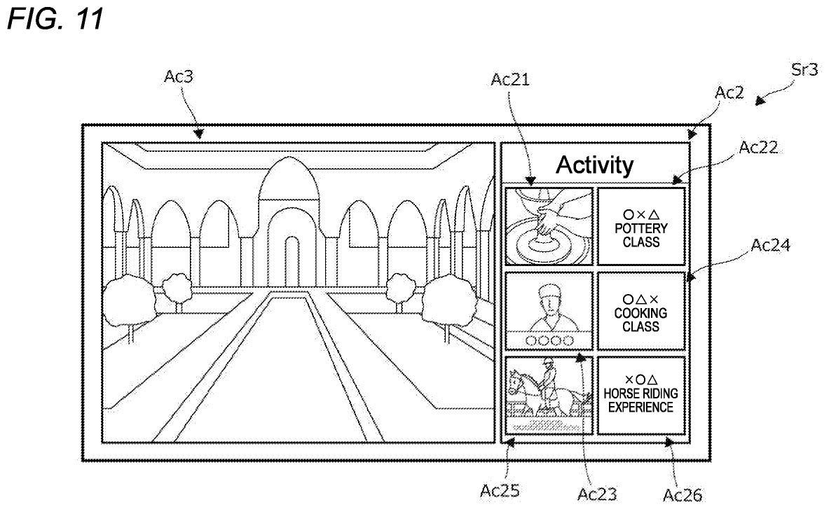

FIG. 11 is a diagram showing an example of an output screen Sr3 of the substitute object information (details). The output screen Sr3 shown in FIG. 11 shows an example in which a more detailed image Ac3 is displayed for substitute object information for which it is determined that the occupant has a high degree of interest. The display region Ac2 shows an example in which each of the evaluation information Ev1 to Ev3 for each substitute object information is not displayed, and description thereof will be omitted.

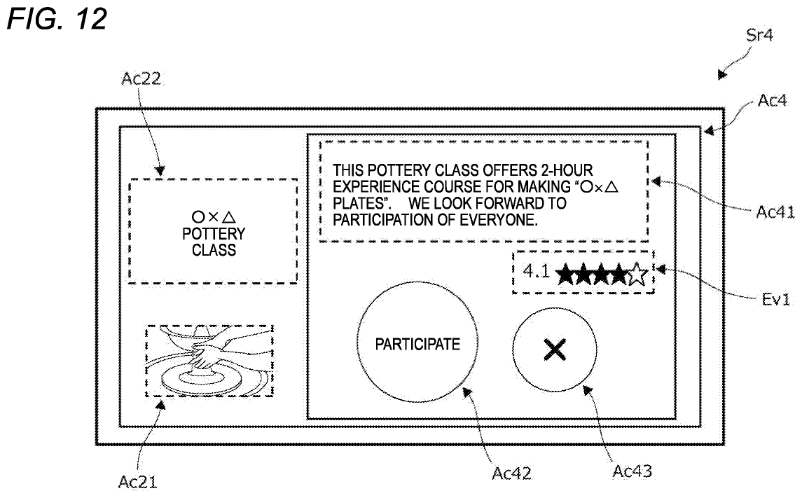

FIG. 12 is a diagram showing an example of a reservation screen Sr4 for substitute object information. The reservation screen Sr4 shown in FIG. 12 is a screen for inputting whether to make a reservation regarding the substitute object information for which it is determined that the occupant has a high degree of interest.

When determining that the occupant (user) has a high degree of interest, the processor 21 generates the reservation screen Sr4 and outputs the generated reservation screen Sr4 to the monitor 24. A display region Ac4 includes the summary Ac22, the evaluation information Ev1, introduction information Ac41, a participation button Ac42, and a return button Ac43. The introduction information Ac41 displays an introductory document created by an event provider and saying that “this pottery class offers a 2-hour experience course for making “◯xΔ plates”. We look forward to participation of everyone”. The introduction information Ac41 may display information such as the participation expense.

The participation button Ac42 is a button for accepting an input operation of the occupant (user), and the input operation is performed when a line of sight of the driver stays longer than a predetermined time or when an operation based on touch operation is accepted. Based on the input operation, the processor 21 may interlock with the terminal device P1 and perform an operation such as a telephone reservation and a net reservation necessary for participation, or may only simply perform setting of the substitute object information.

The return button Ac43 is a button for accepting an input operation of the occupant (user), and the input operation is performed when the line of sight of the driver stays longer than a predetermined time or when an operation based on a touch operation is accepted. Based on the input operation of the return button Ac43, the processor 21 may return to the output screen Sr2, or may display other substitute object information that has not been displayed yet.

As described above, the vehicle navigation system according to the first embodiment includes the camera CR that captures the occupant in the vehicle C1 and can detect the line-of-sight direction of the occupant based on a captured image of the occupant, and the in-vehicle device CN1 including the monitor 24 that can accept an operation of the occupant and can display information, in which the camera CR detects the line-of-sight direction of the driver among occupants, and transmits a detection result including the line-of-sight direction of the driver and the captured image to the in-vehicle device CN1. Based on the received detection result and the line-of-sight direction of the driver, the in-vehicle device CN1 accepts an input operation for information displayed on the monitor 24 and accepts a touch operation on the monitor 24 by an occupant in a passenger seat.

Accordingly, the vehicle navigation system according to the first embodiment can accept an input operation in consideration of safety according to the vehicle information and the traveling state of the vehicle C1.

The in-vehicle device CN1 of the vehicle navigation system according to the first embodiment acquires a traveling speed of the vehicle C1, and accepts a touch operation on the monitor 24 by the driver when the vehicle C1 is stopped. Accordingly, the vehicle navigation system according to the first embodiment can accept an input operation in consideration of safety according to the vehicle information and the traveling state of the vehicle C1.

The in-vehicle device CN1 of the vehicle navigation system according to the first embodiment acquires a traveling speed of the vehicle C1, and accepts a touch operation on the monitor 24 by the driver when the acquired traveling speed of the vehicle C1 is equal to or smaller than a predetermined speed and continues for a predetermined distance. Accordingly, the vehicle navigation system according to the first embodiment can accept an input operation in consideration of safety according to the vehicle information and the traveling state of the vehicle C1.

The in-vehicle device CN1 of the vehicle navigation system according to the first embodiment acquires information on a driving automation level set for the vehicle C1, and accepts a touch operation on the monitor 24 by the driver when the driving automation level is level 2 or higher. Accordingly, the vehicle navigation system according to the first embodiment can accept an input operation in consideration of safety according to the vehicle information and the traveling state of the vehicle C1.

The vehicle navigation system according to the first embodiment further includes the microphone MC that can collect a sound of the occupant. The microphone MC converts the collected sound of the occupant into an audio signal and transmits the converted audio signal to the in-vehicle device CN1. The in-vehicle device CN1 recognizes the received audio signal and accepts an input operation based on the recognized audio signal. Accordingly, since the vehicle navigation system according to the first embodiment enables an input operation by sound, it is possible to accept an input operation in consideration of safety according to the vehicle information and the traveling state of the vehicle C1.

The in-vehicle device CN1 of the vehicle navigation system according to the first embodiment is communicably connected to a roadside device disposed on a roadside of a road, generates information on a route to a destination based on object information including the destination of the vehicle C1 input by the occupant, building information indicating whether the destination is outside a building or inside the building, and information on an arrival time at the destination, acquires, from the roadside device, traffic information on the generated route and weather information of the destination, determines whether the object information is satisfied based on the acquired traffic information and weather information, and outputs a determination result thereof to the monitor 24. Accordingly, the vehicle navigation system according to the first embodiment can notify the occupant whether a schedule indicated by the object information is possible, and when the schedule cannot be achieved, the occupant can quickly plan another schedule.

The vehicle navigation system according to the first embodiment further includes the server S1 that collects and stores information on a facility within a predetermined distance from the destination and a satisfaction degree for the facility, and information on an even held within a predetermined distance from the destination and a satisfaction degree for the event information. The in-vehicle device CN1 is communicably connected to the server S1 and transmits the object information to the server S1. The server S1 generates, based on the destination, the arrival time, and the weather information of the destination from the received object information, achievable substitute object information from the stored facility or event information having a satisfaction degree or a higher satisfaction degree and transmits the generated substitute object information to the in-vehicle device CN1. The in-vehicle device CN1 outputs the received substitute object information to the monitor 24. Accordingly, the vehicle navigation system according to the first embodiment can provide other substitute object information at the same destination even when the schedule indicated by the object information cannot be achieved.

The vehicle navigation system according to the first embodiment further includes (i) the server S1 that collects and stores information on a facility within a predetermined distance from the destination and a satisfaction degree for the facility, and information on an even held within a predetermined distance from the destination and a satisfaction degree for the event information, and (ii) the terminal device P1 that is communicably connected to the server S1 and can input the object information. The in-vehicle device CN1 is communicably connected to the terminal device P1 and transmits the object information to the terminal device P1. The terminal device P1 transmits the received object information to the server S1. The server S1 generates, based on the destination, the arrival time, and the weather information of the destination from the received object information, achievable substitute object information from the stored facility or event information having a satisfaction degree or a higher satisfaction degree and transmits the generated substitute object information to the terminal device P1. The terminal device P1 transmits the received substitute object information to the in-vehicle device CN1. The in-vehicle device CN1 outputs the received substitute object information to the monitor 24. Accordingly, the vehicle navigation system according to the first embodiment can provide other substitute object information at the same destination even when the schedule indicated by the object information cannot be achieved.

The substitute object information provided by the vehicle navigation system according to the first embodiment is experience-based event information held at a set destination at a predetermined time. Accordingly, the vehicle navigation system according to the first embodiment can provide substitute object information of the same destination.

The substitute object information provided by the in-vehicle device CN1 and the vehicle navigation system according to the first embodiment is information on a commercial facility within a predetermined distance from the set destination. Accordingly, the vehicle navigation system according to the first embodiment can provide substitute object information of the same destination.

The substitute object information provided by the in-vehicle device CN1 and the vehicle navigation system according to the first embodiment is generated when the object information of the occupant is subjected to a change operation. Accordingly, the vehicle navigation system according to the first embodiment can generate and provide substitute object information of the same destination at a timing desired by the occupant.

The in-vehicle device CN1 of the vehicle navigation system according to the first embodiment acquires information on a driving automation level set for the vehicle C1, determines whether a traveling speed of the vehicle C1 is equal to or smaller than a predetermined speed and continued for a distance equal to or smaller than a predetermined distance when the driving automation level is not level 2 or higher, determines whether the line-of-sight direction of the driver faces the monitor 24 when the traveling speed of the vehicle C1 is equal to or smaller than the predetermined speed and continued for the predetermined distance, and does not cause the monitor to display the substitute object information when the line-of-sight direction of the driver faces the monitor 24. Accordingly, the vehicle navigation system according to the first embodiment can provide substitute object information while considering safety according to the vehicle information and the traveling state of the vehicle.

The in-vehicle device CN1 of the vehicle navigation system according to the first embodiment extracts a facial expression of the occupant based on a captured image, determines a degree of interest in the substitute object information based on the facial expression of the occupant, and changes output time of the substitute object information when the degree of interest is equal to or larger than a predetermined threshold after the substitute object information is displayed. Accordingly, the vehicle navigation system according to the first embodiment can provide substitute object information while considering safety according to the vehicle information and the traveling state of the vehicle.

The in-vehicle device CN1 of the vehicle navigation system according to the first embodiment extracts a facial expression of the occupant based on a captured image, determines a degree of interest in the substitute object information based on the facial expression of the occupant, and outputs introduction information showing a content of the substitute object information when the degree of interest is equal to or larger than a predetermined threshold after the substitute object information is displayed. Accordingly, the vehicle navigation system according to the first embodiment can provide substitute object information while considering safety according to the vehicle information and the traveling state of the vehicle.

The vehicle navigation system according to the first embodiment further includes a microphone MC that can collect a sound of the occupant. The microphone MC converts the collected sound into an audio signal and transmits the converted audio signal to the in-vehicle device CN1. The in-vehicle device CN1 determines a degree of interest of the occupant in the substitute object information based on the received audio signal, and changes output time of the substitute object information when the degree of interest is equal to or larger than a predetermined threshold after the substitute object information is displayed. Accordingly, the vehicle navigation system according to the first embodiment can provide substitute object information according to the degree of interest of the occupant.

The vehicle navigation system according to the first embodiment further includes a speaker that can output a sound and outputs the substitute object information by sound. Accordingly, the vehicle navigation system according to the first embodiment can provide substitute object information while considering safety according to the vehicle information and the traveling state of the vehicle.

The vehicle navigation system according to the first embodiment stores past object information and previously generated past substitute object information, and a past satisfaction degree for the past object information and a past satisfaction degree for the past substitute object information, measures a data communication amount required between the terminal device P1 and the server S1 when it is determined that the object information cannot be satisfied, and generates and outputs substitute object information whose past satisfaction degree is equal to or higher than a predetermined satisfaction degree based on the destination, the arrival time, and the weather information of the destination when the data communication amount is equal to or larger than a predetermined data amount. Accordingly, the vehicle navigation system according to the first embodiment can reduce a communication fee for the terminal device P1.

Although various embodiments have been described above with reference to the accompanying drawings, the present disclosure is not limited to these embodiments. It is obvious that a person skilled in the art can conceive of various modifications, alterations, replacements, additions, deletions, and equivalents within the scope of the invention disclosed in the claims, and it is understood that they naturally fall within the technical scope of the present disclosure. Each component in the various embodiments mentioned above may be combined arbitrarily in the range without deviating from the spirit of the invention.

The present disclosure is useful as a vehicle navigation system that can perform an input operation and information provision in consideration of safety according to vehicle information and a traveling state of a vehicle, and as a method for controlling the vehicle navigation system.

The present application claims the benefit of priority under Japanese Patent Application No. 2019-122139 filed on Jun. 28, 2019, the contents of which are incorporated herein by reference.

1. A method for controlling a vehicle navigation system, the vehicle navigation system comprising: an in-vehicle camera configured to capture at least one occupant in a vehicle and detect a line-of-sight direction of the at least one occupant based on a captured image of the at least one occupant; and an in-vehicle device comprising a touchscreen configured to accept an operation of the at least one occupant and display information, the method comprising:
acquiring a detection result comprising a line-of-sight direction of a driver of the at least one occupant and the captured image; and
accepting an input operation for information displayed on the touchscreen and accepting a touch operation on the touchscreen by an occupant in a passenger seat, based on the line-of-sight direction of the driver from the detection result.

2. The method according to claim 1, further comprising:
acquiring a traveling speed of the vehicle; and
accepting a touch operation on the touchscreen by the driver if the vehicle is stopped.

3. The method according to claim 1, further comprising:
acquiring a traveling speed of the vehicle; and
accepting a touch operation on the touchscreen by the driver if the acquired traveling speed of the vehicle is equal to or smaller than a predetermined speed and continued for a predetermined distance.

4. The method according to claim 1, further comprising:
acquiring information on a driving automation level set for the vehicle; and
accepting a touch operation on the touchscreen by the driver if the driving automation level is level 2 or higher.

5. The method according to claim 1,
wherein the vehicle navigation system further comprises a microphone configured to collect a sound of the at least one occupant, and
wherein the method further comprises:
converting the sound of the at least one occupant collected by the microphone into an audio signal;
recognizing the converted audio signal; and
accepting the input operation based on the recognized audio signal.

6. The method according to claim 1,
wherein the in-vehicle device is connected to and configured to communicate with a roadside device disposed on a roadside of a road, and
wherein the method further comprises:
generating information on a route to a destination based on object information comprising: the destination of the vehicle input by the at least one occupant; building information indicating whether the destination is outside a building or inside the building; and information on an arrival time at the destination;
acquiring traffic information on the generated route and weather information of the destination from the roadside device; and
determining whether the object information is satisfied based on the acquired traffic information and weather information, and outputting a determination result of the determination to the touchscreen.

7. The method according to claim 6,
wherein the vehicle navigation system further comprises a server configured to collect and store information on a facility within a predetermined distance from the destination and a satisfaction degree for the facility, and information on an event held within a predetermined distance from the destination and a satisfaction degree for the event information, and
wherein the method further comprises:
generating achievable substitute object information from the stored facility or event information having the satisfaction degree or higher, based on the destination, the arrival time, and the weather information of the destination of the object information; and
outputting the generated substitute object information to the touchscreen.

8. The method according to claim 6,
wherein the vehicle navigation system further comprises:
a server configured to collect and store information on a facility within a predetermined distance from the destination and a satisfaction degree for the facility, and information on an event held within a predetermined distance from the destination and a satisfaction degree for the event information; and
a terminal device connected to and configured to communicate with the server, the terminal device being configured to input the object information, and
wherein the method further comprises:
generating achievable substitute object information from the stored facility or event information having the satisfaction degree or higher, based on the destination, the arrival time, and the weather information of the destination of the object information; and
outputting the generated substitute object information to the touchscreen.

9. The method according to claim 7,
wherein the substitute object information is experience-based information on the event held at the set destination at a predetermined time.

10. The method according to claim 7,
wherein the substitute object information is information on a commercial facility within the predetermined distance from the set destination.

11. The method according to claim 7,
wherein the substitute object information is generated in response to a change operation of the object information by the at least one occupant.

12. The method according to claim 7, further comprising:
acquiring information on a driving automation level set for the vehicle;
determining whether a traveling speed of the vehicle is equal to or smaller than the predetermined speed and continued for a distance equal to or smaller than the predetermined distance if the driving automation level is not level 2 or higher;
determining whether a line-of-sight direction of the driver faces the touchscreen if the traveling speed of the vehicle is equal to or smaller than the predetermined speed and continued for the predetermined distance; and
not displaying the substitute object information on the touchscreen if the line-of-sight direction of the driver faces the touchscreen.

13. The method according to claim 12, further comprising:
extracting a facial expression of the at least one occupant based on the captured image;
determining a degree of interest in the substitute object information based on the facial expression of the at least one occupant; and
changing output time of the substitute object information if the degree of interest is equal to or larger than a predetermined threshold after the substitute object information is displayed.

14. The method according to claim 12, further comprising:
extracting a facial expression of the at least one occupant based on the captured image;
determining a degree of interest in the substitute object information based on the facial expression of the at least one occupant; and
outputting introduction information indicating a content of the substitute object information if the degree of interest is equal to or larger than a predetermined threshold after the substitute object information is displayed.

15. The method according to claim 12,
wherein the vehicle navigation system further comprises a microphone configured to collect a sound of the at least one occupant, and
wherein the method further comprises:
converting the sound of the at least one occupant collected by the microphone into an audio signal;
determining a degree of interest of the at least one occupant in the substitute object information based on the converted audio signal; and
changing output time of the substitute object information if the determined degree of interest is equal to or larger than a predetermined threshold after the substitute object information is displayed.

16. The method according to claim 7,
wherein the in-vehicle device further comprises a speaker configured to output a sound, and
wherein the method further comprises outputting the substitute object information by sound.

17. The method according to claim 8, further comprising:
storing past object information and previously generated past substitute object information, and a past satisfaction degree for the past object information and a past satisfaction degree for the past substitute object information;
measuring a data communication amount required between the terminal device and the server if it is determined that the object information cannot be satisfied; and
generating and outputting the substitute object information having the past satisfaction degree which is equal to or higher than a predetermined satisfaction degree based on the destination, the arrival time, and the weather information of the destination if the data communication amount is equal to or larger than a predetermined data amount.
